(19) United States
(12) Patent Application Publication
(10) Pub. No.: US 2025/0125677 A1
(43) Pub. Date: Apr. 17, 2025

(54) STATOR OF AN ELECTRIC MOTOR

(71) Applicant: Brose Fahrzeugteile SE & Co. Kommanditgesellschaft, Würzburg, Würzburg (DE)

(72) Inventors: Alexander VOLKAMER, Oberscheinfeld (DE); Roman MISCH, Berlin (DE)

(21) Appl. No.: 18/833,514

(22) PCT Filed: Jan. 17, 2023
(86) PCT No.: PCT/EP2023/050969

§ 371 Date: Aug. 16, 2024

(30) Foreign Application Priority Data
Jan. 26, 2022 (DE) 10 2022 200 865.0

(51) Int. Cl. H02K 3/28; H02K 1/14; H02K 11/00

(52) U.S. Cl. CPC H02K 3/28; H02K 1/146; H02K 11/0094; H02K 2203/09

(57) ABSTRACT

A stator of an electric motor has a number of stator teeth carrying a coil winding; a circular ring-shaped interconnection element having a number of insertion pockets with contact elements inserted therein, each having at least one insulation displacement contact; and a contact device which is connected to the interconnection element. The contact device has a number of bus bars corresponding to the number of phases. Each bus bar is inserted, or can be inserted, into a contact slot of one of the contact elements in clamping contact. The insertion pockets have an insertion slot which is open on one axial side and has a first slot for guiding the wire portions and a second slot for receiving the respective bus bar.

The invention relates to a stator of an electric motor, having a number of stator teeth carrying coils of a multi-phase stator winding, and an interconnection element having a number of insertion pockets with contact elements inserted therein, each having at least one insulation displacement contact and at least one contact slot. The invention also relates to an electric motor comprising such a stator.

Such an electric motor is designed as a so-called brushless electric motor (brushless direct current motor, BLDC motor), in which wear-prone brush elements of a mechanical commutator are replaced by electronic commutation of the motor current. A brushless electric motor as an electric (three-phase) machine has a stator with a stator laminated core with a number of stator teeth, for example arranged in a star shape, which carry a rotating electric field or stator winding in the form of individual stator coils, which in turn are wound from an insulating wire. The coils are assigned to individual strings or phases of the machine and are interconnected in a predetermined manner.

In a three-phase electric motor, the stator has a stator winding with three phases and thus, for example, three phase conductors or phase windings, to which electric current is applied out of phase in order to generate a rotating magnetic field in which a rotor or armature, which is usually equipped with permanent magnets, rotates. The phase ends of the phase windings are connected to a contact device to control the electric motor, as presented, for example, in DE 20 2014 005 789 U1 for a printed circuit board or DE 10 2019 206 641 A1 for plug connection. The coils of the rotating field winding are interconnected in a certain way, for example by means of an interconnection element placed on the front of the stator. The type of interconnection is determined by the winding scheme of the rotating field winding, wherein a star connection or a delta connection of the phase windings is common as a winding scheme.

To interconnect the coils, at least one wire portion of the winding wire to be contacted is inserted into a first slot of a cuboid insertion pocket of the interconnection element and mechanically fixed inside the insertion pocket with an insulation displacement contact of the electrically conductive contact element that can be inserted into the insertion pocket. The contact element is inserted in the direction of the stator by means of a press-in tool, which is positioned on the side of the contact element axially facing away from the insulation displacement contact at a horizontal upper edge.

In addition to applying a certain axial press-in force to the contact element, a defined press-in depth is also required to ensure reliable contacting of the wire portion. This means that the contact element must not be completely immersed in the insertion pocket, but the insertion pocket must be dimensioned so that the upper edge of the contact element always protrudes axially from the insertion pocket. In other words, there must be constant contact between the press-in tool and the contact element during the press-fit process.

The insulation displacement contact of the contact element has a cutting edge which, when inserted into the insertion pocket, cuts through the insulation of the wire portion of the coil winding located in the first slot in such a way that, when an insulation displacement contact is inserted, a core of the winding wire is electrically conductively coupled to the insulation displacement contact. On the side axially opposite the insulation displacement contact, the contact element has an axially extending contact slot into which a busbar of a contact device can be inserted or plugged for electrical clamping contact. The contact device can be designed as a printed circuit board carrying the motor electronics or as a plug connection. In accordance with the geometric conditions, the assembly or realization of an electrical connection of the contact device and the contact element is carried out in the context of a so-called blind assembly, i.e., the electrical connection of the busbar cannot be made under optically accessible conditions. The contact device and therefore also the contact element is therefore checked as part of a quality test (end-of-line test) by connecting it to a power supply. If a current flows via the contact device and the contact element, it is assumed that the installation has been carried out correctly.

The fact that the busbars are not always aligned or positioned in line with the contact slots during assembly of the contact device has proven to be problematic, particularly in the case of tolerance deviations. As a result, the busbar comes to rest on the upper edge of the contact element and bends or kinks sideways. Despite the incorrect clamping contact between the busbar and the contact element, however, current can still flow, i.e., incorrect contact is not detected by the end-of-line test. During operation of the electric motor, in particular due to operational vibrations, the busbar may then break off, causing the electric motor to fail.

The invention addresses the problem of specifying a particularly suitable stator for an electric motor. In particular, a particularly simple and functionally reliable contacting of a customer-specific power source, a plug connection, a switching unit or motor electronics located on a printed circuit board with the connection points of the stator winding is to be realized. The invention also addresses the problem of specifying a particularly suitable electric motor comprising such a stator.

With regard to the stator, the problem is solved with the features of claims 1 and with regard to the electric motor with the features of claim 10. Advantageous embodiments and developments are the subject of the dependent claims (subclaims). The advantages and embodiments cited with regard to the stator can also be applied mutatis mutandis to the electric motor.

The stator according to the invention is provided and set up for an electric motor, in particular a brushless electric motor. The stator has, for example, a stator laminated core with a number of stator teeth arranged, for example, in a star shape. The stator teeth can be arranged individually or as a one-piece stator ring. The stator teeth carry a multi-phase stator or rotating field winding. This means that the stator teeth are wound or wrapped with a winding wire or coil wire. The stator winding is preferably designed in the form of several coils, wherein the coils are suitably connected to each other in a phase-selective manner to form phase strings. Both single coils and interconnected double coils are conceivable. The stator also has an interconnection element, which is placed on an end face of the stator laminated core, particularly on the pole shoe side. A one-piece interconnection element per stator tooth as part of a slot insulation is also conceivable. The interconnection element has a segmented, circular-ring-like wall as a termination for the coils. The termination projects axially beyond the stator laminated core along an axial direction in the assembled state.

The interconnection element is designed with a number of insertion pockets with contact elements inserted or pressed into them. The insertion pockets are, for example, formed in one piece, i.e., in one piece or monolithically, on the interconnection element, can be part of the termination and thus also protrude axially beyond the stator laminated core. In this case, the insertion pockets each have an insertion slot which is open on one axial side in relation to the circular interconnection element, into which electrically conductive, preferably metal, contact elements are inserted, each with at least one insulation displacement contact as an interconnection point for a wire portion of interconnected coils. The insertion slots extending on the interconnection element, preferably tangentially, have at least one first slot for guiding the wire portions, which extends substantially orthogonally to the insertion slot and consequently radially with respect to the interconnection element.

The stator also has a contact device mounted on the interconnection element, at least in portions. The contact device is either circular, circular-arc or circular-ring sector-shaped or rectangular, for example, and can either have a plug connection or a contact carrier in the form of a printed circuit board with a number of busbars corresponding to the number of phases.

The busbars are inserted or can be inserted into a contact slot (clamping slot, contact gap) of one of the contact elements in clamping contact. In other words, the busbars engage in the contact slot of the associated contact element in the manner of a blade contact, for example. The contact slots of the contact elements thus serve to accommodate at least one portion of the busbars.

As the busbar is at least partially immersed axially in the region of the insertion pocket when inserted and the busbar is generally wider than the insertion pocket, the latter is equipped with a recess in the form of a second slot that extends parallel to the first slot. This second slot is therefore used to accommodate the busbar during installation, if necessary. To improve or facilitate the guidance of the busbar, the second slot can be designed with a V-shaped insertion slope. This allows the busbar to be inserted into the contact slot of the contact element in a targeted manner.

Irrespective of the orientation of the insertion pocket in relation to the circular interconnection element (radial or tangential), the first and second slots extend substantially orthogonally to the longitudinal extent of the insertion pocket. In other words, in the exemplary embodiment discussed here (of a tangentially extending insertion slot), the first and second slots extend radially.

In order to avoid the outlined problem of incorrect contact and thus to ensure perfect electrical contact between the busbar and the contact slot, the insertion pocket is designed in the region of the second, preferably radially extending slot in such a way that it projects axially beyond the contact element inserted therein. As a result, a busbar that is not exactly aligned with the contact slot comes into contact with the non-electrically conductive plastic of the insertion pocket or the interconnection element. As the contact device and interconnection element move closer together, the busbar bends sideways, wherein it remains, however, on the insertion pocket that protrudes axially on the contact element. Incorrect contact is therefore avoided.

As also mentioned, the contact element is inserted in the direction of the stator by means of a press-in tool, which is adapted to the geometry of the insertion pocket and which attaches in portions to a horizontal upper edge of the contact element on the side axially facing away from the insulation displacement contact. Since the insertion pocket only projects axially beyond the contact element in the region of the contact slot, only the lateral ends of the contact element, i.e., the lateral ends of the contact element tangentially facing away from the contact slot, can therefore serve as contact for the press-in tool. In other words, the insertion pocket releases the contact element at its lateral ends for the press-in tool to rest against. During assembly, the press-in tool can thus be used to press the busbars reliably into the respective contact slots of the associated contact elements.

The contact element is inserted or pressed into each of the insertion pockets as an insulation displacement contact plug. In a first variant, the contact element has two spaced-apart insulation displacement contacts as connection points for the wire portions of the coils inserted in the first two slots. These are suitably spaced apart from each other and are conveniently provided on the same side of the contact element. The contact element is thus designed as an insulation displacement contact pair or as a double insulation displacement contact plug (double IDC). The contact slot is preferably arranged centrally, i.e., between the two insulation displacement contacts on their axially opposite side. The insulation displacement contacts are preferably arranged relative to each other in such a way that the contact element is axially symmetrical.

In a second variant, in contrast to the first variant, the contact element has only a single insulation displacement contact, wherein the contact slot and the insulation displacement contact lie axially one above the other. The insertion pocket associated with this second variant means that the second slot is not provided for guiding wire portions of the coils, but for holding a busbar of a contact device and is thus axially aligned with the first radially extending slot. In other words, the first and second slots coincide.

Furthermore, the contact device can be mounted substantially independently of the interconnection element. This means that during assembly of the stator or the electric motor, the stator winding is assembled or connected to the interconnection element and to the contact device in separate or distinct assembly steps. In other words, the stator winding carried by the stator teeth is interconnected, pre-assembled and provided by means of the interconnection element, in particular forming phase strings in a phase-selective manner. A corresponding contact device can then be fitted, taking into account the requirements of the desired application.

Here and in the following, “axial” or an “axial direction” is understood in particular to mean a direction parallel (coaxial) to the axis of rotation of the electric motor, i.e., perpendicular to the end faces of the stator. Accordingly, “radial” or a “radial direction” is understood here and in the following to mean in particular a direction perpendicular (transverse) to the axis of rotation of the electric motor along a radius of the stator or the electric motor. Here and in the following, “tangential” or a “tangential direction” is understood in particular to mean a direction along the circumference of the stator or the electric motor (circumferential direction, axial direction), i.e., a direction perpendicular to the axial direction and the radial direction.

The busbars are preferably attached to the plug connection or the printed circuit board by an integrally bonded connection and/or an interlocking connection and/or frictional engagement. The conjunction “and/or” is to be understood here and in the following in such a way that the features linked by means of this conjunction can be formed both together and as alternatives to each other.

An “integral bond” or an “integrally bonded connection” between at least two interconnected parts is understood here and in the following to mean in particular that the interconnected parts are held together at their contact surfaces by material union or cross-linking (for example due to atomic or molecular bonding forces), possibly under the action of an additive.

An “interlocking fit” or an “interlocking connection” between at least two connected parts is understood here and in the following to mean in particular that the connected parts are held together at least in one direction by a direct interlocking of the contours of the parts themselves or by an indirect interlocking via an additional connecting part. The “blocking” of a relative movement in this direction is therefore down to shape.

A “frictional engagement” or a “frictionally engaged connection” between at least two parts connected to each other is understood here and in the following to mean in particular that the parts connected to each other are prevented from sliding against each other due to a frictional force acting between them. If a “connection force” that causes this frictional force is missing (this means the force that presses the parts against each other, for example a screw force or the weight force itself), the frictionally engaged connection cannot be maintained and can therefore be released.

In the following, exemplary embodiments of the invention are explained in greater detail with reference to a drawing, in which:

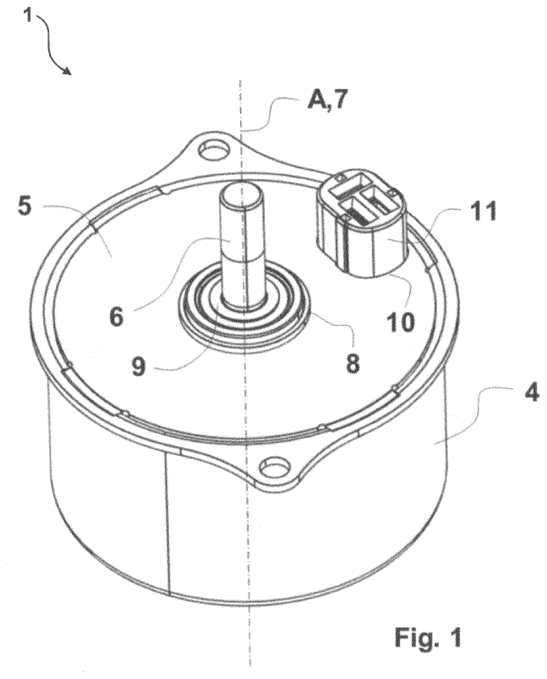

FIG. 1 is a perspective view of an electric motor with a contact device in the form of a plug connection,

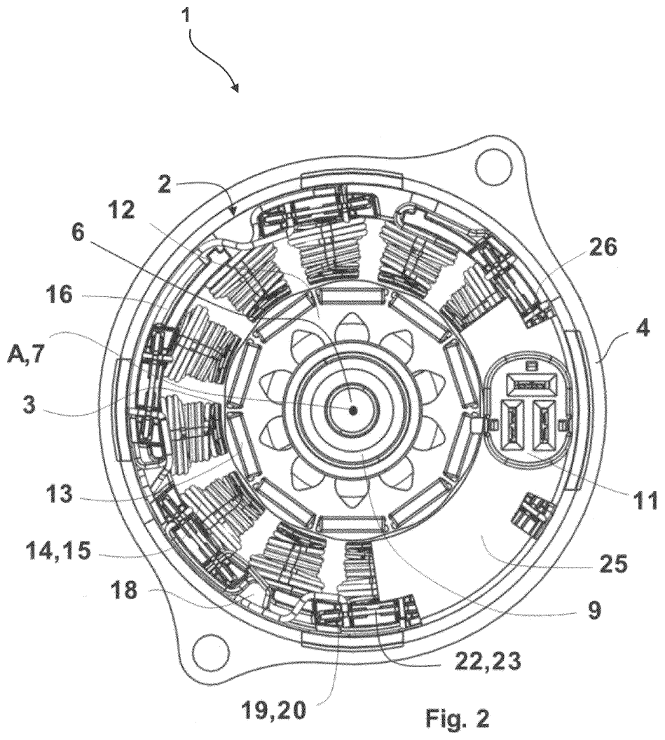

FIG. 2 is a plan view of the electric motor shown in FIG. 1 without end shield,

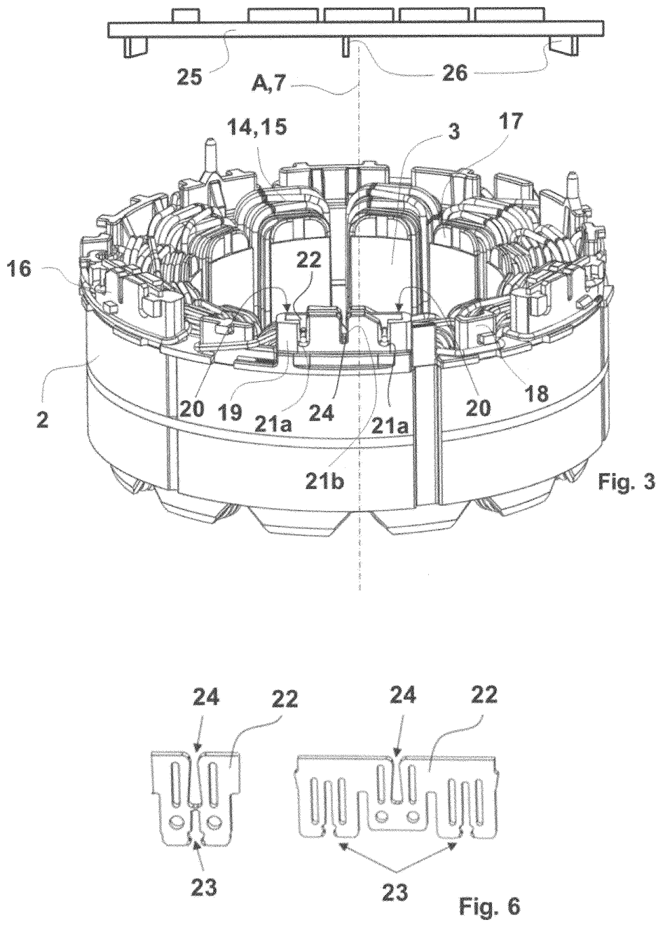

FIG. 3 is a perspective view of a stator of the electric motor with a contact device in the form of a printed circuit board,

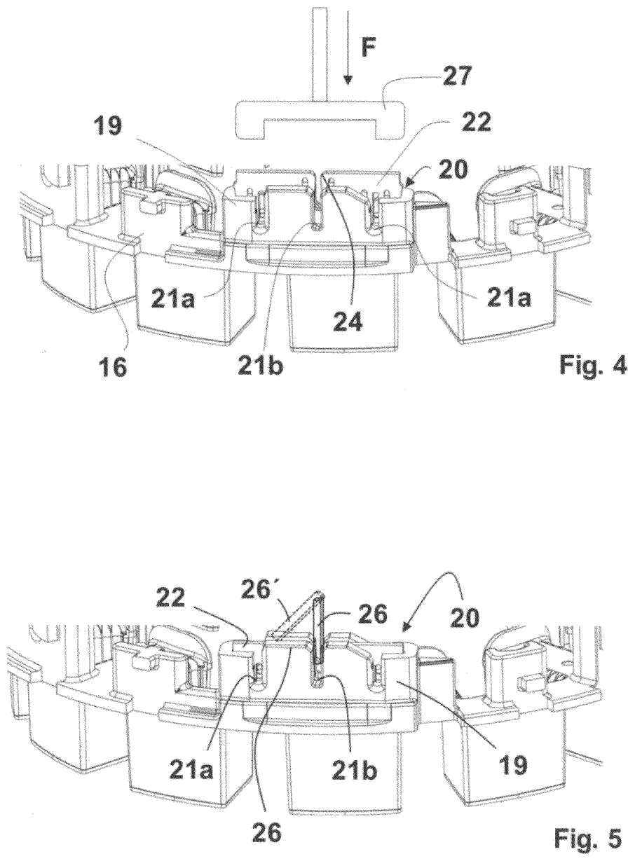

FIG. 4 is a perspective view of part of an interconnection element of the stator during the assembly of a contact element,

FIG. 5 shows the interconnection element according to FIG. 4 after assembly of the contact element, and

FIG. 6 shows the contact element in two alternative embodiments.

Corresponding parts and sizes are always provided with the same reference signs in all figures.

FIG. 1 shows a brushless electric motor 1. The electric motor 1 is embodied, for example, as an actuator for a brake system of a motor vehicle, as a drive motor for an e-bike or as a drive motor for an e-scooter. The electric motor 1 has a pole pot as the motor housing 4, which is closed at the end face by means of an end shield 5. The end shield 5 has a central recess for a motor shaft (rotor shaft) 6, which runs coaxially to a motor axis 7. A bearing seat 8 for a roller bearing 9 is suitably provided in the region of this recess. Opposite the bearing seat 8, a second bearing seat, not shown, is formed in the base of the motor housing 4, in which a second rolling bearing, not shown, is inserted. The motor shaft 6 is rotatably mounted about the motor axis 7 by means of the roller bearings. The end shield 6 has a feed-through (opening) 10 on the radially outer side, through which a plug connection 11 of a stator 2 shown in FIG. 2 passes.

The electric motor 1 is embodied as an internal rotor motor with the stator 2 on the radially outer side and a rotor 12 joined fixedly to the motor shaft 6. In the assembled state, the rotor 12 is rotatably mounted inside the fixed stator 2 so that it can rotate about the motor axis 7 along an axial direction A. The rotor 22 (not shown in detail) is formed by a laminated core in which permanent magnets 13 are inserted to generate an excitation field.

The stator 2 has an unspecified stator laminated core with a circumferential stator yoke, from which a number of stator teeth 3 extend radially inwards (FIG. 3). The stator laminated core is provided with a coil winding 14 for generating a magnetic rotating field.

According to FIG. 3, the stator 2 has a three-phase coil winding 14, which is wound onto the stator teeth 3 in the form of (stator) coils 15. The coils 15 marked with reference signs are connected to each other in a phase-selective manner, forming phase strings or phase windings. In this embodiment, the stator laminated core has an approximately star-shaped arrangement with twelve inwardly directed stator teeth 3, wherein one phase winding per phase of the coil winding 14 is wound around two adjacent stator teeth 3 and around the two stator teeth 3 arranged diametrically opposite each other in the stator laminated core to form a magnetic pole. During operation of the electric motor 1, an electric current flows through the three phase windings, thus forming six magnetic pole regions of the stator 2.

To guide, route and connect the phase windings on the stator teeth 3, the stator 2 has a routing or interconnection ring as an interconnection element 16. The interconnection element 16 is fitted axially onto one end face of the stator laminated core. The ring-shaped interconnection element 16, which is made of an insulating plastics material, has an annular body on which twelve half-sleeve-like coil formers 17 are formed on the stator plate side as pole shoe-like receptacles for the stator teeth 3. In the plugged-on state, the stator teeth 3 are thus substantially surrounded by the insulating coil formers 17 of the interconnection element 16 in such a way that only the pole shoe ends of the stator teeth 3 are exposed. The coils 15 or phase windings are wound around the stator teeth 3 with an insulated copper wire (coil wire, winding wire) on the coil formers 17 of the interconnection element 16.

The interconnection element 16 shown in FIG. 3 has a segmented, circular-ring-like wall as termination 18. As can also be seen, the termination 18 projects axially beyond the stator laminated core along the axial direction A in the assembled state. When winding the coils 15, the coil or winding wires are guided through the termination 18 on the circumferential side behind the stator teeth 3 during the winding process to form the magnetic poles. To form the phase strings or phase winding, the coils 15 are electrically connected to each other at their coil ends and/or a wire portion (coil section) located between them. For this purpose, the interconnection element 16 has three insertion pockets 19 distributed around the circumference, which are molded on in one piece, i.e., integrally or monolithically. The insertion pockets 19 are formed in particular as pairs of insertion pockets, each of which has two tangentially extending insertion slots 20, open on one axial side. The insertion pockets 19 also each have two radially directed first slots 21a, through which the wire portions of the coils 15 are guided.

A metal contact element 22 is inserted or pressed into each of the insertion pockets 19 as an insulation displacement contact plug. The contact element 22 shown on the right-hand side in FIG. 6 as first variant has two insulation displacement contacts 23 as interconnection points for the wire portions of the coils 15 inserted in the two first slots 21a. The contact element 22 is thus embodied as an insulation displacement contact pair or as a double insulation displacement contact connector (double IDC). The insulation displacement contacts 23 are arranged relative to each other in such a way that the contact element 22 is axially symmetrical. In the assembled state, an insulation displacement contact 23 is inserted into one of the insertion slots 20 of the insertion pocket 19. The insulation displacement contacts 23 are arranged at a distance from one another and are provided on the same axial side of the contact element 22. On the axially opposite side of the contact element 22, a clamping or contact slot 24 accessible from there is arranged between the insulation displacement contacts 23 and runs parallel to the insulation displacement contacts 23 or to the first radially directed slots 21a of the insertion pocket 19. In the clamping-contacted state of the wire portions of the coils 15, the contact slot 24 is arranged radially aligned with a second radially directed slot 21b of the insertion pocket 19, which runs parallel to the first slots 21a.

As can be seen in FIG. 2, the contact device 25 is positioned axially on the end-shield-side interconnection element 16 when the stator 2 is in the assembled state. The contact device 25 is designed as a plug connection of the stator 18 or the electric motor 1. The contact device 25 is embodied in the shape of a ring sector and has a contact carrier with the plug connection 11, which is in particular integrally molded on it.

FIG. 3, on the other hand, alternatively shows the contact device 25 in the form of a printed circuit board. The electrical connection between the contact element 22 and the contact device 25 is made via blade-like busbars 26 arranged in or on the contact device 25, each of which can be embodied as an approximately L-shaped stamped-and-bent part. The busbars 26, which are radially oriented or aligned with respect to the insertion pockets 19, are each inserted into a contact slot 24 of one of the contact elements 22 in such a way that they make terminal contact.

FIGS. 4 and 5 show the assembly of the contact element 22 within the interconnection element 16. As illustrated in FIG. 4, the contact element 22 is pre-positioned in a first step with the insulation displacement contacts 23 first in the insertion slot 20 of the insertion pocket 19. Once a certain press-in depth of the contact element 22 has been reached, further pressing-in takes place by means of a press-in tool 27, which is applied to a horizontally extending upper edge of the contact element 22 on the side axially facing away from the insulation displacement contact 23. For this purpose, the insertion pocket 19 releases the contact element 22 at its lateral tangential ends for contact with the press-in tool 27. The press-in tool 27, which is subjected to a defined press-in force F, ensures that the insulation displacement contacts 23 make secure electrical contact with the wire portion of the coils 15 guided in the first slot 21a.

For this purpose, the insulation displacement contact 23 of the contact element 22 has a cutting edge which, when inserted into the insertion pocket 19, cuts through the insulation of the wire portion of the coils 15 located in the first slot 21a in such a way that, when the insulation displacement contact 23 is inserted, a core of the winding wire is electrically conductively coupled to the insulation displacement contact 23. The contact device 25 is then guided axially with the busbar 26 leading into the radially directed slot 21b, which is equipped with a V-shaped insertion slope at its open end to support the guidance of the busbar 26.

To ensure perfect electrical contact between the busbar 26 and the contact slot 24, the insertion pocket 19 is also designed in the region of the second radially extending slot 21b in such a way that it projects axially beyond the contact element 22 inserted therein.

According to FIG. 5, this means that a busbar 26′ that is bent sideways due to a misalignment only comes into contact with the non-electrically conductive plastic of the insertion pocket 19 or the interconnection element 18. When the contact device 22 is fitted on the interconnection element 18, a misalignment of the busbar 26′ therefore does not lead to an electrical connection.

The contact element 22 shown on the left-hand side in FIG. 6 as the second variant, in contrast to the first variant, has a single insulation displacement contact 23, wherein the contact slot 24 lies axially one above the other with the insulation displacement contact 23. The insertion pocket 19 associated with this second variant, which is not shown, means that the second slot 21b is not provided for guiding wire portions of the coils 15, but for receiving a busbar 26 of a contact device 22 and is thus aligned with the first radially directed slot 21a.

To summarize, the invention relates to a stator 2 having a number of stator teeth 3 carrying a coil winding 14, and an interconnection element 16 having a number of insertion pockets 19 with contact elements 22 inserted or insertable therein, each having at least one insulation displacement contact 23, as well as a contact device 25 which is connected to the interconnection element 16, the contact device 25 having a number of busbars 26 corresponding to the number of phases, which busbars 26 are inserted or can be inserted into a contact slot 24 of one of the contact elements 22 in a terminal-contacting manner, wherein the insertion pockets 19 have an insertion slot 20 which is open on one axial side and has a first slot 21a for guiding the wire portions and a second slot 21b for receiving the respective busbar 26.

The claimed invention is not limited to the exemplary embodiments described above. Rather, other variants of the invention may also be derived therefrom by a person skilled in the art within the scope of the disclosed claims without departing from the subject matter of the claimed invention. In particular, all the individual features described in conjunction with the various exemplary embodiments can also be combined in other ways within the scope of the disclosed claims without departing from the subject matter of the claimed invention.

### List of Reference Signs

1 electric motor
2 stator
3 stator teeth
4 motor housing
5 end shield
6 motor shaft
7 motor axis
8 bearing seat
9 rolling bearing
10 feed-through
11 plug connection
12 rotor
13 permanent magnet
14 coil winding
15 coils
16 interconnection element
17 coil former
18 termination
19 insertion pocket
20 insertion slot
21a first slot
21b second slot
22 contact element
23 insulation displacement contact
24 contact slot
25 contact device
26,26′ busbar
27 press-in tool
A axial direction

1-10. (canceled)

11. A stator of an electric motor, the stator comprising:
a number of stator teeth carrying coils of a multi-phase coil winding;
a circular-ring-shaped interconnection element formed with a number of insertion pockets and having contact elements inserted therein, each of said contact elements having at least one insulation displacement contact forming an interconnection point for a wire portion of interconnected coils; and
a contact device electrically connected to said interconnection element,
said contact device having a number of busbars, with the number of said busbars corresponding to a number of phases of said multi-phase coil winding;
each of said busbars being inserted, or insertable, into a contact slot of a respective one of said contact elements in clamping contact; and
said insertion pockets of said interconnection element having an insertion slot which is open on one axial side and which is formed with a first slot for guiding the wire portions and a second slot for receiving a respective said busbar.

12. The stator according to claim 11, wherein said insertion pocket projects axially beyond said contact element inserted therein in a region of said second slot.

13. The stator according to claim 11, wherein said insertion pocket is formed to expose said contact element at lateral ends thereof for contact with a press-in tool.

14. The stator according to claim 11, wherein said contact device is a printed circuit board or a plug connection.

15. The stator according to claim 11, wherein said insulation displacement contact of said contact element is a first insulation displacement contact, and said contract element comprises a second insulation displacement contact spaced apart from said insulation displacement contact.

16. The stator according to claim 15, wherein said contact element is axially symmetrical.

17. The stator according to claim 15, wherein said contact slot is arranged between said first and second insulation displacement contacts on an axially opposite side thereof.

18. The stator according to claim 11, wherein said contact slot, said first slot, and said second slot are axially aligned with one another.

19. The stator according to claim 11, wherein said second slot is formed with a V-shaped insertion slope for insertion of said busbar.

20. An electric motor, comprising a stator according to claim 11.
